(19) United States
(12) Patent Application Publication
(10) Pub. No.: US 2024/0284097 A1
(43) Pub. Date: Aug. 22, 2024

(54) THERMALLY-CONDUCTIVE AND SOUND-ABSORBING COMPOSITE MATERIAL AND PREPARATION METHOD THEREOF, AND SPEAKER

(71) Applicant: AAC Technologies (Nanjing) Co., Ltd., Nanjing (CN)

(72) Inventors: Yuanwei Su, Nanjing (CN); Hezhi Wang, Nanjing (CN); Changliang Wang, Nanjing (CN)

(21) Appl. No.: 18/324,179

(22) Filed: May 26, 2023

Related U.S. Application Data
(63) Continuation of application No. PCT/CN2023/088129, filed on Apr. 13, 2023.

(30) Foreign Application Priority Data
Feb. 20, 2023 (CN) 202310151006.8

(51) Int. Cl. H04R 1/28; B29C 67/24; C08J 5/24; C08K 3/34; C08K 7/00; C09K 5/14

(52) U.S. Cl. CPC H04R 1/288; B29C 67/248; C08J 5/243; C08J 5/249; C08K 3/34; C08K 7/00; C09K 5/14; B29K 2105/162; B29K 2507/04; B29K 2509/00; B29K 2707/04; C08J 2309/06; C08J 2333/04; C08J 2363/00; C08J 2375/04; C08J 2383/04; C08K 2003/343; C08K 2201/001; C08K 2201/005; C08K 2201/011

(57) ABSTRACT

The present disclosure provides a thermally-conductive and sound-absorbing composite material and a preparation method thereof and a speaker. The thermally-conductive and sound-absorbing composite material includes the following components by mass percent: 10-80% of an activated carbon felt, 5-75% of zeolite particles, 1-80% of graphene particles and 5-40% of an adhesive, where the activated carbon felt serves as a skeleton; the graphene particles are bonded to an activated carbon fiber surface of the activated carbon felt through the adhesive; and the zeolite particles are bonded to surfaces of the graphene particles and the activated carbon fiber surface of the activated carbon felt through the adhesive. The thermally-conductive and sound-absorbing composite material provided by the present disclosure has excellent heat conductivity, excellent sound absorption performance, and a desirable mechanical strength.

### TECHNICAL FIELD

The present disclosure relates to the technical field of thermally-conductive and sound-absorbing materials, and in particular to a thermally-conductive and sound-absorbing composite material and a preparation method thereof, and a speaker.

### BACKGROUND

With rapid development of electronic technologies, while integration level and power density of electronic components are increased higher, and the dissipated power density and heat productivity of the electronic components are larger, heat dissipation plays a more and more important role. In the related art, sound-absorbing fibers, sound-absorbing cotton, and zeolite particles are commonly used as sound-absorbing materials in a rear cavity of a speaker. However, these sound-absorbing materials have poor thermal conductivity and cannot satisfy requirements of the speaker for a large amplitude and a high power.

In view of this, two methods were proposed to improve the poor thermal conductivity of the sound-absorbing material. In a first method, by directly mixing thermally-conductive particles with sound-absorbing particles, the material has a poor mechanical strength. With pressurization upon mixing, the mechanical strength of the material can be improved, but the sound absorption performance is greatly reduced and is far from satisfactory. In a second method, by either mixing sound-absorbing particles with a porous thermally-conductive bulk material, or mixing thermally-conductive particles with a porous sound-absorbing bulk material, a thermally-conductive and sound-absorbing composite material such as graphene is prepared. The method can improve the thermal conductivity to some extent, but is hard to realize excellent heat conductivity and excellent sound absorption performance.

Therefore, the existing sound-absorbing materials cannot possess the excellent heat conductivity and the excellent sound absorption performance at the same time.

### SUMMARY

An objective of the present disclosure is to provide a thermally-conductive and sound-absorbing composite material, to solve the problem that the existing sound-absorbing materials cannot possess the excellent heat conductivity and the excellent sound absorption performance at the same time.

According to a first aspect, the present disclosure provides a thermally-conductive and sound-absorbing composite material. The thermally-conductive and sound-absorbing composite material includes following components by mass percent: 10%-80% of an activated carbon felt, 5%-75% of zeolite particles, 1%-80% of graphene particles and 5%-40% of an adhesive, wherein the activated carbon felt serves as a skeleton; the graphene particles are bonded to an activated carbon fiber surface of the activated carbon felt through the adhesive; and the zeolite particles are bonded to surfaces of the graphene particles and the activated carbon fiber surface of the activated carbon felt through the adhesive.

As an improvement, macropores having a pore size of 1 μm-1,000 μm are formed among activated carbon fibers of the activated carbon felt.

As an improvement, micropores having a pore size of smaller than 2 nm are formed in the activated carbon fiber surface of the activated carbon felt; and a proportion of pore volume of the micropores accounts for 5%-95%.

As an improvement, the zeolite particles have a particle size of 50 nm to 1 mm.

As an improvement, the graphene particles each have a flake-like structure, and have a particle size of 0.1 μm-50 μm.

As an improvement, the adhesive is one or more selected from a group consisting of an acrylate adhesive, a styrene-butadiene rubber (SBR) adhesive, a polyurethane adhesive, an epoxy adhesive and a silicone adhesive.

According to a second aspect, the present disclosure provides a preparation method of a thermally-conductive and sound-absorbing composite material. The preparation method of a thermally-conductive and sound-absorbing composite material includes following steps:
S1: cutting the activated carbon felt according to a shape of a rear cavity of a speaker, so as to match with the rear cavity of the speaker;
S2: mixing the zeolite particles, the graphene particles and the adhesive with a foaming agent and a dispersant to obtain a thermally-conductive and sound-absorbing fluid;
S3: soaking the cut activated carbon felt into the thermally-conductive and sound-absorbing fluid to obtain a thermally-conductive and sound-absorbing composite material precursor;
S4: quick-freezing the thermally-conductive and sound-absorbing composite material precursor to shape the thermally-conductive and sound-absorbing composite material precursor;
S5: freeze-drying the thermally-conductive and sound-absorbing composite material precursor shaped to remove the dispersant in the thermally-conductive and sound-absorbing composite material precursor;
S6: baking the thermally-conductive and sound-absorbing composite material precursor after the dispersant is removed, so that the adhesive in the thermally-conductive and sound-absorbing composite material precursor is cured;
S7: ultrasonically cleaning the thermally-conductive and sound-absorbing composite material precursor with water after the adhesive is cured, so that the foaming agent, unfirmly bonded zeolite particles and unfirmly bonded graphene particles in the thermally-conductive and sound-absorbing composite material precursor are removed; and
S8: drying the thermally-conductive and sound-absorbing composite material precursor ultrasonically cleaned to remove moisture in the thermally-conductive and sound-absorbing composite material precursor, thereby obtaining the thermally-conductive and sound-absorbing composite material.

As an improvement, in step S2, in parts by mass, there are 100 parts of the zeolite particles, 1-300 parts of the graphene particles, 1-200 parts of the adhesive, 1-50 parts of the foaming agent, and 50-9,900 parts of the dispersant.

As an improvement, in step S2, the foaming agent is one or more selected from a group consisting of a physically volatile foaming agent, a thermally decomposable foaming agent and a bi-component reactive foaming agent.

According to a second aspect, the present disclosure provides a speaker. A rear cavity of the speaker is filled with the thermally-conductive and sound-absorbing composite material mentioned in the first aspect.

Compared with the related art, the thermally-conductive and sound-absorbing composite material provided by the present disclosure includes the activated carbon felt, the zeolite particles, the graphene particles and the adhesive. The activated carbon felt serves as a skeleton material to support the thermally-conductive and sound-absorbing composite material. Through cooperation between the activated carbon felt with excellent sound absorption performance and the zeolite particles with excellent sound absorption performance, sound absorption performance of the thermally-conductive and sound-absorbing composite material is further improved. In addition, the activated carbon felt and the graphene particles are a carbon-based material. The graphene particles with excellent heat conductivity can further be dispersed and firmly bonded to the activated carbon fibers of the activated carbon felt to form continuous heat-conducting grids, thereby improving thermal conductivity of the thermally-conductive and sound-absorbing composite material. Moreover, the graphene particles can further increase bonding contact areas of the zeolite particles, thereby improving a loading capacity of the zeolite particles, and significantly improving the sound absorption performance of the thermally-conductive and sound-absorbing composite material. Therefore, the thermally-conductive and sound-absorbing composite material has the excellent thermal conductivity, excellent sound absorption performance and a desirable mechanical strength.

### BRIEF DESCRIPTION OF DRAWINGS

In order to more clearly illustrate the technical solutions in the embodiment of the present disclosure, the drawings used in the description of the embodiment will be briefly described below. It is obvious that the drawings in the following description are only some embodiments of the present disclosure. For those skilled in the art, other drawings can be obtained according to these drawings without creative efforts. In the drawings:

FIG. 1 is a flowchart of a preparation method of a thermally-conductive and sound-absorbing composite material according to an embodiment of the present disclosure;

FIG. 2 is a structural schematic diagram of a thermally-conductive and sound-absorbing composite material according to an embodiment of the present disclosure; and

FIG. 3 is scanning electron microscopy (SEM) images at different magnifications of a thermally-conductive and sound-absorbing composite material according to an embodiment of the present disclosure.

### DETAILED DESCRIPTION OF EMBODIMENTS

The technical solutions in the embodiment of the present disclosure will be clearly and completely described below. It is obvious that the described embodiments are only a part of, not all of, the embodiments. All other embodiments obtained by those of ordinary skill in the art based on the embodiments of the present disclosure without creative efforts should fall within the protection scope of the present disclosure.

An embodiment of the present disclosure provides a thermally-conductive and sound-absorbing composite material, including the following components by mass percent: 10%-80% of an activated carbon felt, 5%-75% of zeolite particles, 1%-80% of graphene particles and 5%-40% of an adhesive. The activated carbon felt serves as a skeleton. The graphene particles are bonded to an activated carbon fiber surface of the activated carbon felt through the adhesive. The zeolite particles are bonded to surfaces of the graphene particles and the activated carbon fiber surface of the activated carbon felt through the adhesive.

The activated carbon felt is porous, with a specific surface area of 100 m²/g-1,800 m²/g. Macropores having a pore size of 1 μm-1,000 μm and optionally having the pore size of 100 μm-500 μm are formed among activated carbon fibers of the activated carbon felt. Micropores having a pore size of smaller than 2 nm are formed in the activated carbon fiber surface of the activated carbon felt. A proportion of pore volume of the micropores accounts for 5%-95%. The activated carbon fibers of the activated carbon felt may also be referred to as activated carbon felt fibers. Between the activated carbon felt fibers, there are abundant macroporous structures and a large number of the micropores.

The zeolite particles have a particle size of 50 nm to 1 mm, optionally 50 nm to 500 μm, and more optionally 100 nm to 100 μm. The zeolite particles may be fine powder or particles, and may also be secondarily formed zeolite particles.

The graphene particles each have a flake-like structure, and have a particle size of 0.1 μm-50 μm.

The adhesive is one or more selected from a group consisting of an acrylate adhesive, an SBR adhesive, a polyurethane adhesive, an epoxy adhesive and a silicone adhesive.

Optionally, the thermally-conductive and sound-absorbing composite material includes the following components by mass percent: 15%-50% of the activated carbon felt, 20%-60% of the zeolite particles, 10%-50% of the graphene particles and 5%-35% of the adhesive.

In this embodiment, the graphene particles are bonded to the activated carbon fiber surface of the activated carbon felt through the adhesive to form continuous heat-conducting grids.

In this embodiment, the acrylate adhesive is one or more selected from a group consisting of a methyl acrylate adhesive, an ethyl acrylate adhesive, a butyl acrylate adhesive, an isooctyl acrylate adhesive, a methyl methacrylate adhesive and an ethyl methacrylate adhesive. The SBR adhesive is one or two of the group consisting of a high-temperature emulsion-polymerized SBR adhesive and a low-temperature emulsion-polymerized SBR adhesive. The polyurethane adhesive is one or more selected from a group consisting of a polyisocyanate adhesive, an isocyanate-containing polyurethane adhesive, a hydroxyl-containing polyurethane adhesive and a polyurethane resin adhesive. The epoxy adhesive is one or more selected from a group consisting of a cold-curing adhesive, a thermo-curing adhesive and a photocuring adhesive. The silicone adhesive is one or more selected from a group consisting of an adhesive with silicone resin as a matrix and an adhesive with silicone rubber as a matrix.

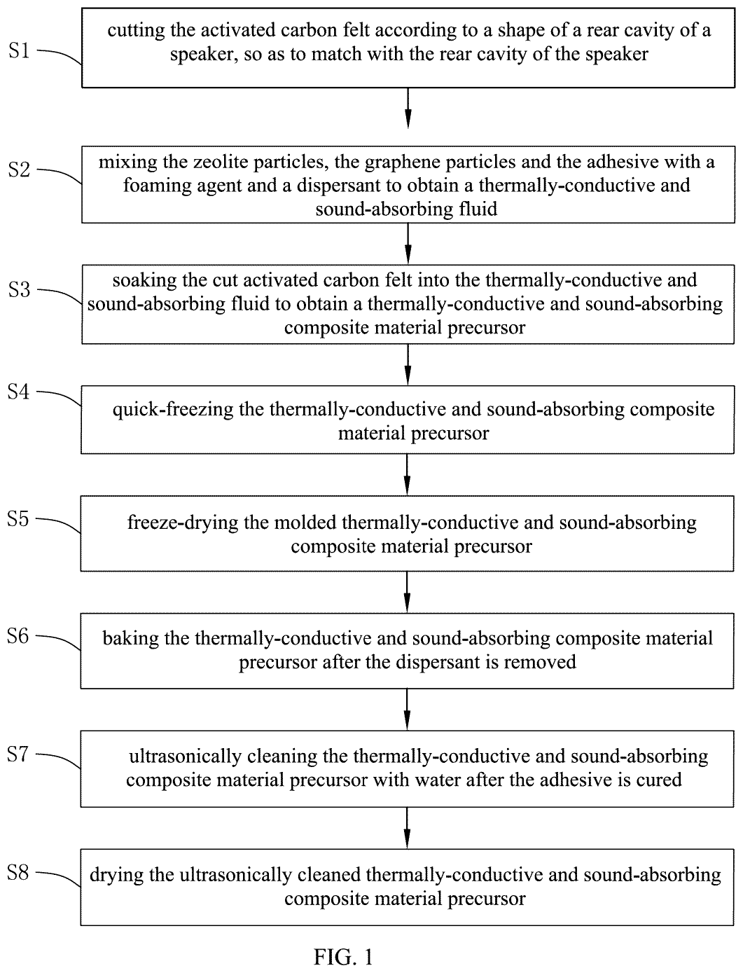

As shown in FIG. 1, the preparation method of the thermally-conductive and sound-absorbing composite material includes the following steps.

S1: The activated carbon felt is cut according to a shape of a rear cavity of a speaker, so as to match with the rear cavity of the speaker.

A shape of the cut activated carbon felt is matched with the shape of the rear cavity of the speaker.

S2: The zeolite particles, the graphene particles and the adhesive are mixed with a foaming agent and a dispersant to obtain a thermally-conductive and sound-absorbing fluid.

In this embodiment, there are 100 parts of the zeolite particles, 1-300 parts of the graphene particles, 1-200 parts of the adhesive, 1-50 parts of the foaming agent and 50-9,900 parts of the dispersant. Optionally, there are 5-30 parts of the adhesive, 7-40 parts of the foaming agent and 135-1,800 parts of the dispersant.

In this embodiment, the foaming agent is one or more selected from a group consisting of a physically volatile foaming agent, a thermally decomposable foaming agent and a bi-component reactive foaming agent. Optionally, the dispersant is water.

The physically volatile foaming agent includes, but is not limited to, a water-soluble low-boiling point organic solvent soluble. The organic solvent is one or more selected from a group consisting of ethanol, acetone, methanol, isopropanol and tetrahydrofuran. The thermally decomposable foaming agent is a persulfide foaming agent, an azo-compound foaming agent and a bicarbonate foaming agent. The persulfide is one or more selected from a group consisting of potassium persulfate and ammonium persulfate. The azo-compound is one or more selected from a group consisting of azodicarbonamide and azodiisobutyronitrile. The bicarbonate is one or more selected from a group consisting of sodium bicarbonate and potassium bicarbonate. The bi-component reactive foaming agent is one or more selected from a group consisting of carbonate and hydrochloric acid, and bicarbonate and hydrochloric acid. The carbonate is one or more selected from a group consisting of sodium carbonate, potassium carbonate, calcium carbonate and barium carbonate. The bicarbonate is one or more selected from a group consisting of sodium bicarbonate, potassium bicarbonate, calcium bicarbonate and barium bicarbonate.

S3: The cut activated carbon felt is soaked into the thermally-conductive and sound-absorbing fluid to obtain a thermally-conductive and sound-absorbing composite material precursor.

The thermally-conductive and sound-absorbing composite material precursor can also be referred to as a graphene doped zeolite and activated carbon felt thermally-conductive and sound-absorbing composite material precursor. The soaking time is 1 h-24 h. However, when a method such as an ultrasonic method or a vacuum method is used, infiltration can be accelerated. In this case, the soaking time is shortened to 1 min-60 min, provided that the activated carbon felt is completely infiltrated by the thermally-conductive and sound-absorbing fluid.

Upon completion of the soaking process, the thermally-conductive and sound-absorbing composite material precursor can be wiped gently to remove the excessive thermally-conductive and sound-absorbing fluid on the surface, for ease of proceeding of a next step.

S4: The thermally-conductive and sound-absorbing composite material precursor is quick-frozen.

The quick-freezing process is intended to shape the thermally-conductive and sound-absorbing composite material precursor.

It is realized at a low temperature by either a refrigerating device or a refrigerant.

S5: The thermally-conductive and sound-absorbing composite material precursor shaped is freeze-dried.

The freeze-drying process is intended to remove the dispersant in the thermally-conductive and sound-absorbing composite material precursor.

It can be realized by a freeze dryer. There are no limits made on freezing temperature and time, provided that the dispersant in the thermally-conductive and sound-absorbing composite material precursor can be removed completely.

S6: The thermally-conductive and sound-absorbing composite material precursor is baked after the dispersant is removed.

The baking process is intended to cure the adhesive in the thermally-conductive and sound-absorbing composite material precursor.

While the thermally-conductive and sound-absorbing composite material precursor is baked, the adhesive can be cured. Baking temperature and time are set according to the adhesive used, provided that the adhesive can be cured completely, namely the graphene particles are firmly bonded to the activated carbon fiber surface of the activated carbon felt, and the zeolite particles are firmly bonded to the surfaces of the graphene particles.

S7: The thermally-conductive and sound-absorbing composite material precursor is ultrasonically cleaned with water after the adhesive is cured.

The ultrasonic cleaning process is intended to remove the foaming agent, unfirmly bonded zeolite particles and unfirmly bonded graphene particles in the thermally-conductive and sound-absorbing composite material precursor.

The water used is optionally deionized water. The ultrasonic cleaning process is realized by an ultrasonic cleaner. There are no limits made on a cleaning frequency and cleaning time, provided that the foaming agent, the unfirmly bonded zeolite particles and the unfirmly bonded graphene particles in the thermally-conductive and sound-absorbing composite material precursor can be removed completely.

S8: The ultrasonically cleaned thermally-conductive and sound-absorbing composite material precursor is dried.

The drying process is intended to remove moisture in the thermally-conductive and sound-absorbing composite material precursor, thereby obtaining the thermally-conductive and sound-absorbing composite material.

It can be realized by a drying oven. Typically, the drying temperature is 80° C.-150° C., and the drying time is 0.5 h-2 h.

Compared with the related art, the thermally-conductive and sound-absorbing composite material provided by the present disclosure includes the activated carbon felt, the zeolite particles, the graphene particles and the adhesive. The activated carbon felt serves as a skeleton material to support the thermally-conductive and sound-absorbing composite material. Through cooperation between the activated carbon felt with excellent sound absorption performance and the zeolite particles with excellent sound absorption performance, sound absorption performance of the thermally-conductive and sound-absorbing composite material is further improved. In addition, the activated carbon felt and the graphene particles are a carbon-based material. The graphene particles with excellent heat conductivity can further be dispersed and firmly bonded to the activated carbon fibers of the activated carbon felt to form continuous heat-conducting grids. This improves thermal conductivity of the thermally-conductive and sound-absorbing composite material. Moreover, the graphene particles can further increase bonding contact areas of the zeolite particles, thereby improving a loading capacity of the zeolite particles, and significantly improving the sound absorption performance of the thermally-conductive and sound-absorbing composite material. Therefore, the thermally-conductive and sound-absorbing composite material has the excellent thermal conductivity, excellent sound absorption performance and desirable mechanical strength, and is extremely valuable.

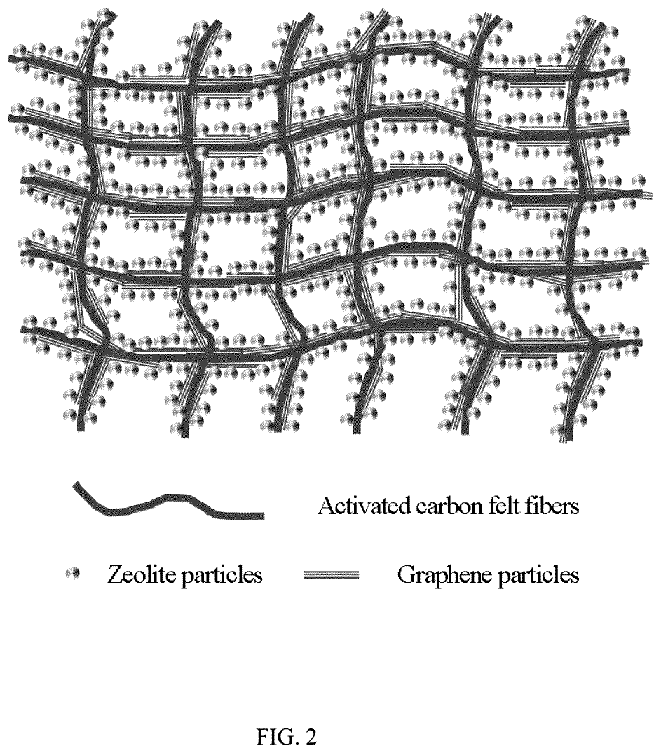

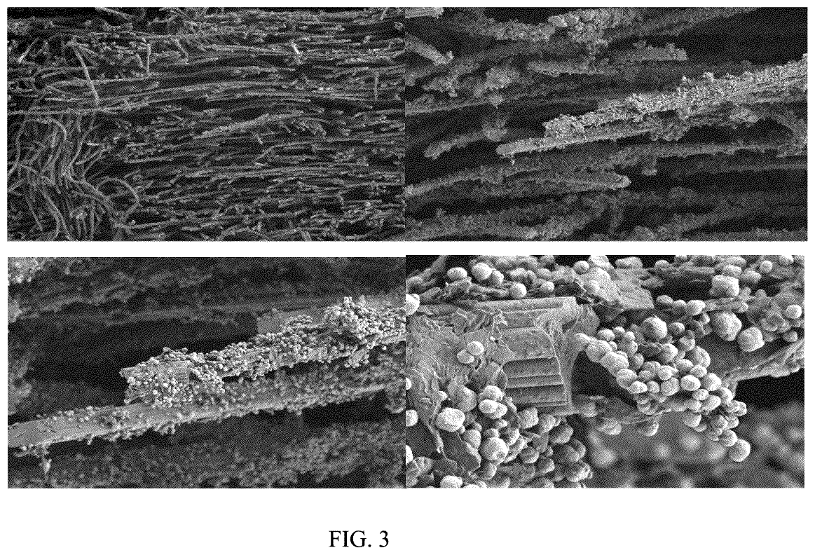

In order to better describe the thermally-conductive and sound-absorbing composite material in this embodiment, FIG. 2 illustrates a structural schematic diagram of a thermally-conductive and sound-absorbing composite material, and FIG. 3 is scanning electron microscopy (SEM) images at different magnifications of a thermally-conductive and sound-absorbing composite material according to an embodiment of the present disclosure.

An embodiment of the present disclosure further provides a speaker. A rear cavity of the speaker is filled with the thermally-conductive and sound-absorbing composite material. In this embodiment, because of the thermally-conductive and sound-absorbing composite material filled in the rear cavity of the speaker, the speaker can achieve the technical effects of the thermally-conductive and sound-absorbing composite material, which will not be repeated.

Additionally, the speaker can further yield more stable low frequency performance, which has been applied to fields of mobile phones, headsets, computers, vehicles, televisions, audios, etc.

For the sake of better illustration on the preparation method of the thermally-conductive and sound-absorbing composite material, three examples are provided hereinafter for description:

### Example 1

In this example, a preparation method of the thermally-conductive and sound-absorbing composite material includes the following steps: the activated carbon felt was cut according to a shape of a rear cavity of a speaker. 100 parts of the zeolite particles, 100 parts of the graphene particles, 40 parts of the adhesive, 40 parts of the foaming agent and 1,000 parts of the water were uniformly mixed to obtain a thermally-conductive and sound-absorbing fluid for a later use. The cut activated carbon felt was soaked into the thermally-conductive and sound-absorbing fluid for 1 h. The completely infiltrated activated carbon felt was taken out, wiped gently and quickly to remove the excessive thermally-conductive and sound-absorbing fluid on a surface, and quick-frozen for shaping. Freeze-drying was performed with a freeze dryer to completely remove moisture in the material. High-temperature baking (baking time and temperature depended on a curing condition of the adhesive and a foaming condition of the foaming agent) was performed, such that the adhesive was cured completely, the graphene particles was firmly bonded to the activated carbon fibers of the activated carbon felt, and the zeolite particles were firmly bonded to the surfaces of the zeolite particles, thereby obtaining the thermally-conductive and sound-absorbing composite material. FIG. 2 shows morphology of the thermally-conductive and sound-absorbing composite material.

### Example 2

In this example, a preparation method of the thermally-conductive and sound-absorbing composite material includes the following steps: the activated carbon felt was cut according to a shape of a rear cavity of a speaker. 200 parts of the zeolite particles, 100 parts of the graphene particles, 30 parts of the adhesive, 30 parts of the foaming agent and 1,200 parts of the water were uniformly mixed to obtain a thermally-conductive and sound-absorbing fluid for a later use. The cut activated carbon felt was soaked into the thermally-conductive and sound-absorbing fluid for 1 h. The completely infiltrated activated carbon felt was taken out, wiped gently and quickly to remove the excessive thermally-conductive and sound-absorbing fluid on a surface, and quick-frozen for shaping. Freeze-drying was performed with a freeze dryer to completely remove moisture in the material. High-temperature baking (baking time and temperature depended on a curing condition of the adhesive and a foaming condition of the foaming agent) was performed, such that the adhesive was cured completely, the graphene particles was firmly bonded to the activated carbon fibers of the activated carbon felt, and the zeolite particles were firmly bonded to the surfaces of the zeolite particles, thereby obtaining the thermally-conductive and sound-absorbing composite material.

### Example 3

In this example, a preparation method of the thermally-conductive and sound-absorbing composite material includes the following steps: the activated carbon felt was cut according to a shape of a rear cavity of a speaker. 300 parts of the zeolite particles, 100 parts of the graphene particles, 50 parts of the adhesive, 60 parts of the foaming agent and 1,500 parts of the water were uniformly mixed to obtain a thermally-conductive and sound-absorbing fluid for a later use. The cut activated carbon felt was soaked into the thermally-conductive and sound-absorbing fluid for 1 h. The completely infiltrated activated carbon felt was taken out, wiped gently and quickly to remove the excessive thermally-conductive and sound-absorbing fluid on a surface, and quick-frozen for shaping. Freeze-drying was performed with a freeze dryer to completely remove moisture in the material. High-temperature baking (baking time and temperature depended on a curing condition of the adhesive and a foaming condition of the foaming agent) was performed, such that the adhesive was cured completely, the graphene particles was firmly bonded to the activated carbon fibers of the activated carbon felt, and the zeolite particles were firmly bonded to the surfaces of the zeolite particles, thereby obtaining the thermally-conductive and sound-absorbing composite material.

In order to better describe technical effects of the above three examples, the thermally-conductive and sound-absorbing composite materials prepared in the three specific examples and other sound-absorbing materials are respectively placed into suitable tools. A reduced value of a resonant frequency (F0) is tested with an impedance analyzer. Through a drop test, drop and damage of the thermally-conductive and sound-absorbing composite material are tested. A reduction of F0 represents a degree of moving from the resonant frequency to the low frequency. Typically, the greater the F0 reduced value, the better the low frequency performance of the speaker. The rear cavity of the speaker for testing acoustic performance has a volume of 0.4 cm3 (0.4 cc).

The test data are shown in Table 1:

TABLE 1
Test results of the examples in acoustic performance

| | | F0 | |
|---|---|---|---|
| | | reduced | |
| | F0 | value | Drop and |
| Sample | (Hz) | (Hz) | damage |
| No sound-absorbing material is filled | 1039 | — | — |
| in the rear cavity of the speaker | | | |
| Sound-absorbing foams are filled in | 994 | 45 | No damage and |
| the rear cavity of the speaker | | | no peeling |
| Sound-absorbing fibers are filled in | 996 | 43 | No damage and |
| the rear cavity of the speaker | | | no peeling |
| A treated activated carbon felt (a | 925 | 114 | No damage and |
| skeleton material with a large number | | | no peeling |
| of micropores in the example) is filled | | | |
| in the rear cavity of the speaker | | | |
| Sound-absorbing particles are filled in | 801 | 238 | No damage and |
| the rear cavity of the speaker | | | no peeling |
| The thermally-conductive and | 877 | 162 | No damage and |
| sound-absorbing composite material | | | no peeling |
| prepared in Example 1 is filled in the | | | |
| rear cavity of the speaker | | | |
| The thermally-conductive and | 834 | 175 | No damage and |
| sound-absorbing composite material | | | no peeling |
| prepared in Example 2 is filled in the | | | |
| rear cavity of the speaker | | | |
| The thermally-conductive and | 768 | 201 | No damage and |
| sound-absorbing composite material | | | no peeling |
| prepared in Example 3 is filled in the | | | |
| rear cavity of the speaker | | | |

In addition, an LFA447 laser flash analyzer is further used to conduct a test according to ASTM-E1530-06. The sample was prepared into a 112 mm×83 mm×2 mm sheet. Five positions on the sheet were cut to obtain five specimens. The specimens were wiped with alcohol. A graphite layer was uniformly sprayed. The graphite layer was blow-dried with a rubber suction bulb. The specimens were put into a tester. The testing temperature was 25° C. Test results are as shown in Table 2.

TABLE 2
Test results of the examples in acoustic performance

| | Conductive |
|---|---|
| | coefficient |
| Sample | (W/M · k) |
| Activated carbon felt | 0.15 |
| Zeolite | 0.17 |
| Bass particles | 0.16 |
| Activated carbon felt and zeolite composite sound- | 0.17 |
| absorbing material | |
| Thermally-conductive and sound-absorbing composite | 3.7 |
| material in Example 1 | |
| Thermally-conductive and sound-absorbing composite | 2.9 |
| material in Example 2 | |
| Thermally-conductive and sound-absorbing composite | 2.1 |
| material in Example 3 | |

As can be seen from comparison results in Table 1 and Table 2, the thermally-conductive and sound-absorbing composite material in the embodiment is not as good as the Bass particles (sound-absorbing particles) in sound absorption performance, but has a desirable mechanical strength and no peeling. The thermally-conductive and sound-absorbing composite material has obviously better thermal conductivity than the activated carbon felt, the zeolite, and the activated carbon felt and zeolite composite sound-absorbing material. This indicates that the thermally-conductive and sound-absorbing composite material in the embodiments has high cost performance and a huge application value.

The foregoing is merely examples of the present disclosure and does not constitute a limitation on the scope of the present disclosure. Any equivalent structure or equivalent process change made by using the description and the accompanying drawings of the present disclosure, or direct or indirect application thereof in other related technical fields, shall still fall in the protection scope of the patent of the present disclosure.

What is claimed is:

1. A thermally-conductive and sound-absorbing composite material, comprising following components by mass percent: 10%-80% of an activated carbon felt, 5%-75% of zeolite particles, 1%-80% of graphene particles and 5%-40% of an adhesive, wherein the activated carbon felt serves as a skeleton; the graphene particles are bonded to an activated carbon fiber surface of the activated carbon felt through the adhesive; and the zeolite particles are bonded to surfaces of the graphene particles and the activated carbon fiber surface of the activated carbon felt through the adhesive.

2. The thermally-conductive and sound-absorbing composite material as described in claim 1,
wherein macropores having a pore size of 1 μm-1,000 μm are formed among activated carbon fibers of the activated carbon felt.

3. The thermally-conductive and sound-absorbing composite material as described in claim 2, wherein micropores having a pore size of smaller than 2 nm are formed in the activated carbon fiber surface of the activated carbon felt; and a proportion of pore volume of the micropores accounts for 5%-95%.

4. The thermally-conductive and sound-absorbing composite material as described in claim 1,
wherein the zeolite particles have a particle size of 50 nm to 1 mm.

5. The thermally-conductive and sound-absorbing composite material as described in claim 1,
wherein the graphene particles each have a flake-like structure, and have a particle size of 0.1 μm-50 μm.

6. The thermally-conductive and sound-absorbing composite material as described in claim 1, wherein the adhesive is one or more selected from a group consisting of an acrylate adhesive, a styrene-butadiene rubber (SBR) adhesive, a polyurethane adhesive, an epoxy adhesive and a silicone adhesive.

7. A preparation method of a thermally-conductive and sound-absorbing composite material, wherein the thermally-conductive and sound-absorbing composite material comprises following components by mass percent: 10%-80% of an activated carbon felt, 5%-75% of zeolite particles, 1%-80% of graphene particles and 5%-40% of an adhesive, wherein the activated carbon felt serves as a skeleton; the graphene particles are bonded to an activated carbon fiber surface of the activated carbon felt through the adhesive; and the zeolite particles are bonded to surfaces of the graphene particles and the activated carbon fiber surface of the activated carbon felt through the adhesive; and
the preparation method comprises following steps:
S1: cutting the activated carbon felt according to a shape of a rear cavity of a speaker, so as to match with the rear cavity of the speaker;
S2: mixing the zeolite particles, the graphene particles and the adhesive with a foaming agent and a dispersant to obtain a thermally-conductive and sound-absorbing fluid;
S3: soaking the cut activated carbon felt into the thermally-conductive and sound-absorbing fluid to obtain a thermally-conductive and sound-absorbing composite material precursor;
S4: quick-freezing the thermally-conductive and sound-absorbing composite material precursor to shape the thermally-conductive and sound-absorbing composite material precursor;
S5: freeze-drying the thermally-conductive and sound-absorbing composite material precursor shaped to remove the dispersant in the thermally-conductive and sound-absorbing composite material precursor;
S6: baking the thermally-conductive and sound-absorbing composite material precursor after the dispersant is removed, so that the adhesive in the thermally-conductive and sound-absorbing composite material precursor is cured;
S7: ultrasonically cleaning the thermally-conductive and sound-absorbing composite material precursor with water after the adhesive is cured, so that the foaming agent, unfirmly bonded zeolite particles and unfirmly bonded graphene particles in the thermally-conductive and sound-absorbing composite material precursor are removed; and
S8: drying the thermally-conductive and sound-absorbing composite material precursor ultrasonically cleaned to remove moisture in the thermally-conductive and sound-absorbing composite material precursor, thereby obtaining the thermally-conductive and sound-absorbing composite material.

8. The preparation method of the thermally-conductive and sound-absorbing composite material as described in claim 7, wherein in step S2, in parts by mass, there are 100 parts of the zeolite particles, 1-300 parts of the graphene particles, 1-200 parts of the adhesive, 1-50 parts of the foaming agent, and 50-9,900 parts of the dispersant.

9. The preparation method of the thermally-conductive and sound-absorbing composite material as described in claim 7, wherein in step S2, the foaming agent is one or more selected from a group consisting of a physically volatile foaming agent, a thermally decomposable foaming agent and a bi-component reactive foaming agent.

10. A speaker, wherein a rear cavity of the speaker is filled with a thermally-conductive and sound-absorbing composite material, and the thermally-conductive and sound-absorbing composite material comprises following components by mass percent: 10%-80% of an activated carbon felt, 5%-75% of zeolite particles, 1%-80% of graphene particles and 5%-40% of an adhesive, wherein the activated carbon felt serves as a skeleton; the graphene particles are bonded to an activated carbon fiber surface of the activated carbon felt through the adhesive; and the zeolite particles are bonded to surfaces of the graphene particles and the activated carbon fiber surface of the activated carbon felt through the adhesive.
